(19) United States
(12) Patent Application Publication
(10) Pub. No.: US 2013/0035975 A1
(43) Pub. Date: Feb. 7, 2013

(54) CROSS-MEDIA ATTRIBUTION MODEL FOR ALLOCATION OF MARKETING RESOURCES

(71) Applicants: David Cavander, Los Angeles, CA (US); Dominique Hanssens, Santa Monica, CA (US); Satya Ramachandran, Fremont, CA (US); Anupam Singh, San Jose, CA (US); Amit Paunikar, Los Angeles, CA (US); Jon Vein, Los Angeles, CA (US); Wes Nichols, Pacific Palisades, CA (US); Peter Kamvysselis, Santa Monica, CA (US)

(72) Inventors: David Cavander, Los Angeles, CA (US); Dominique Hanssens, Santa Monica, CA (US); Satya Ramachandran, Fremont, CA (US); Anupam Singh, San Jose, CA (US); Amit Paunikar, Los Angeles, CA (US); Jon Vein, Los Angeles, CA (US); Wes Nichols, Pacific Palisades, CA (US); Peter Kamvysselis, Santa Monica, CA (US)

(21) Appl. No.: 13/204,585

(22) Filed: Aug. 5, 2011

(51) Int. Cl. G06Q 10/06

(52) U.S. Cl. 705/7.22

(57) ABSTRACT

A software facility that analyzes consumer interactions with one or more marketing campaigns and the results of those interactions to generate a cross-media or cross-channel attribution model representing the true impact of marketing resource allocation decisions is provided. The facility collects, from a plurality of sources, information representing consumer interactions with marketing campaigns and any results of those interactions. The facility aggregates the information to assess or determine the behavior of consumers with respect to different marketing campaigns and marketing channels. The facility analyzes the information according to varying depths or levels of channel granularity to generate models representative of the true impact of resources allocated to each channel or sub-channel on the performance or effectiveness of the marketing campaign. The facility or other processes may use the generated models to inform future marketing resource allocation decisions.

### CROSS-REFERENCE TO RELATED APPLICATIONS

This application is related to U.S. patent application Ser. No. 12/390,341, filed Feb. 20, 2009, which claims the benefit of the following U.S. Provisional Patent Application Nos. 1) 61/030,550, filed Feb. 21, 2008; 2) 61/084,252, filed Jul. 28, 2008; 3) 61/084,255, filed Jul. 28, 2008; 4) 61/085,819, filed Aug. 1, 2008; and 5) 61/085,820, filed Aug. 1, 2008, U.S. patent application Ser. No. 12/366,937, filed Feb. 6, 2009, U.S. patent application Ser. No. 12/366,958, filed Feb. 6, 2009, U.S. patent application Ser. No. 12/692,577, filed Jan. 22, 2010, which claims the benefit of U.S. Provisional Patent Application No. 61/146,605, filed Jan. 22, 2009, U.S. patent application Ser. No. 12/692,579, filed Jan. 22, 2010, which claims the benefit of U.S. Provisional Patent Application No. 61/146,605, filed Jan. 22, 2009, U.S. patent application Ser. No. 12/692,580, filed Jan. 22, 2010, which claims the benefit of U.S. Provisional Patent Application No. 61/146,605, filed Jan. 22, 2009, and U.S. patent application Ser. No. 12/609,440, filed Oct. 30, 2009. All of the above-identified patent applications are incorporated in their entirety herein by reference.

### BACKGROUND

Marketing communication (“marketing”) is the process by which sellers of a product or a service—i.e., an “offering”—educate potential purchasers or consumers about the offering through, for example, the dissemination of advertisements or marketing messages. Marketing can be a major expense for sellers, and often comprises a large number of components or categories, such as different marketing media (e.g., online, radio, outdoor, television (cable, broadcast, satellite, etc.), display, video games (casual, console, online, MMORPGs, etc.), print, cell phones, personal digital assistants, email, digital video recorders), as well as various marketing techniques, such as direct marketing, promotions, product placement, etc. Furthermore, each marketing medium may include multiple types of marketing outlets or touchpoints—i.e., “channels”—advertising networks, advertising exchanges, search engines, websites, online video sites, television networks, television programs, timeslots for each television network, and so on. Furthermore, each of these “marketing channels” or “advertising channels” may comprise more granular channels or “sub-channels” such as individual advertising networks, individual advertising exchanges, individual search engines, individual online video sites, individual television networks, individual programs or timeslots for each television network, and so on. The proliferation of multiple new and unique media channels has made the task of assessing the relationship between marketing campaigns, marketing channels, and user behavior even more difficult. Despite the complexity involved in developing a marketing budget, allocating a level of spending to each of a number of marketing media and/or marketing channels, and assessing the performance or effectiveness of those allocations, few useful automated decision support tools exist for advertisers, making it common to perform this activity manually, relying on subjective conclusions, and in many cases producing disadvantageous results.

Furthermore, once decisions about cross-media and/or cross-channel marketing resource allocation have been determined, decision support tools do not offer a means by which the tool's user can dynamically or quickly analyze and assess the direct effect or true impact of those allocation decisions and make informed, decisions about future cross-media and/or cross-channel allocation of marketing resources, either holistically or on a per-media or per-channel basis. Finally, known techniques that rely on “last click” or “last impression” direct attribution models are flawed and biased and do not take into account the relationship between different marketing media and marketing channels or a consumer's cross-media or cross-channel experience with a marketing campaign.

### BRIEF DESCRIPTION OF THE DRAWINGS

FIG. 1 is a block diagram of a representative environment in which the facility may operate in some embodiments.

FIG. 2 is a block diagram showing some of the components typically incorporated in at least some of the computer systems and other devices on which the facility executes in some embodiments.

FIG. 3 is a flow diagram illustrating the processing of an analyze component in some embodiments.

FIG. 4 is a data structure diagram illustrating data collected from different sources and how that information may be aggregated in some embodiments.

FIG. 5 is a flow diagram illustrating the processing of a determine true lift factors component in some embodiments.

FIG. 6 is a display page illustrating a marketing resource allocation recommendation and configuration page in some embodiments.

### DETAILED DESCRIPTION

The following description is intended to illustrate various embodiments of the technology. As such, the specific modifications discussed are not to be construed as limitations on the scope of the technology. It will be apparent to one skilled in the art that various equivalents, changes, and modifications may be made without departing from the scope of the technology, and it is understood that such equivalent embodiments are to be included herein.

A software facility that analyzes consumer interactions with marketing or marketing campaigns and the results of those interactions, such as a sale or conversion, to generate a cross-media or cross-channel attribution model representing the true impact of cross-media and cross-channel marketing resource allocation decisions is provided. Furthermore, the facility provides real-time feedback on marketing campaigns and allows for dynamic lift factor adjustment. The facility can use the cross-media attribution model to inform future decisions regarding the cross-media and cross-channel allocation of marketing resources and improve or optimize one or more goals linking the cross-media attribution model to a financial measure related to business outcomes or brand objectives (e.g., revenue growth, increased market share, acquisition of new customers, conversion of leads, upsell, customer retention, marketing expenditure optimization, increase in short term and/or long term profits, increased customer life value, etc. The facility collects historical and real-time data to measure the performance or effectiveness of marketing campaigns with respect to one or more goals and to improve the accuracy of future recommendations for the allocation of marketing resources to marketing channels.

For example, the facility may, in real-time, assess the performance of a marketing campaign for a product, such as, for example, a new shoe. The marketing campaign may include advertisements distributed via a sports news website, e-mail, search engines, and a website that streams television programming. The advertisements direct consumers to the shoe provider's website where the consumers can purchase, among other things, the new shoe. By tracking the distribution of the advertisements via the different marketing channels, the facility can determine the number of times a consumer or group of consumers were presented with advertisements via the different marketing channels associated with the marketing campaign. For example, each time an advertisement is displayed to a consumer via the sports news website or by a search engine, the facility may record cookie information to identify the consumer. Similarly, the facility can record an email address or other identifying information for advertisements presented to each consumer via email or text.

Furthermore, the facility may determine or estimate how many times a consumer interacts with the advertisements by identifying among server logs consumer visits to the shoe provider's website and associate those visits with advertisement impressions. For example, if a consumer streaming a television show online receives an advertisement for the new shoe in association with the stream and clicks on or otherwise interacts with the advertisement to access the shoe provider's website, the user's visit to the website can be associated with the advertisement presented with the streaming television show. Thus, the facility can track the relationship between the presentation of advertisements via different marketing channels and consumer behavior (e.g., visits to a website). Furthermore, the facility can associate results of the consumer's visit(s) to the shoe provider's website with the presentation of advertisements to the consumer. Thus, if the consumer purchases the new shoe, or anything else, the facility can attribute some or all of the revenue generated by the purchase to the marketing campaign and to specific marketing channels through which advertisements for the new shoe were presented to the consumer. Based on these attributions and the allocation of marketing resources to the individual marketing channels associated with the marketing campaign, the facility can assess the performance of each marketing channel in real-time.

The facility collects information representing consumer interactions with marketing campaigns and any results of those interactions, such as how many times an advertisement or advertisements were presented to a consumer, when and how the advertisements were presented to the consumer, how many times the consumer interacted with an advertisement (e.g., clicked on an online advertisement, responded to an email advertisement, watched a video advertisement or portion thereof) and the results of those consumer interactions, such as how much revenue the advertisement generated, whether the consumer purchased or rented an offering, watched an informational video, requested additional information about an offering related to the marketing campaign, and so on.

The facility may collect this information from any of a number of unique data sources, such as advertisers, advertising networks, advertising exchanges, consumers, social networking sites, website analytics data providers, third-party data aggregators, etc. For example, an online advertising network may track the presentation of advertisements to consumers for a particular marketing campaign or campaigns, such as which advertisement was presented, to which consumer, the time the advertisement was presented, whether the consumer interacted with the advertisement, and the result of that interaction. As another example, a cable television provider or digital video recorder service may monitor and provide information relating to the viewing behaviors of its consumers, such as which programs the consumers watch or when and how (e.g., live, recorded, on demand) the consumers watch those programs, which the facility can use to determine which advertisements were presented to a consumer. As another example, online retailers may provide an indication of the products or services that a consumer has purchased or otherwise shown an interest in (e.g., by retrieving information related to the products or services, adding the products or services to a wish list). In some cases, a consumer may provide the facility with information pertaining to how the consumer receives marketing information, such as which websites the consumer frequently visits, which television shows the consumer prefers to watch, whether the consumer watches or fast forwards through commercials, the periodicals to which the consumer subscribes, which radio stations or radio programs the consumer regularly listens to, and so on.

The facility aggregates the collected information to determine or assess the behavior of consumers or groups of consumers with respect to different marketing campaigns. For each marketing campaign, the facility can identify and extract relevant information from each of the sources to ascertain how specific consumers or groups of consumers have interacted with the marketing campaign and identify related results of those interactions. For example, a marketing campaign for a new music album may include television advertisements, magazine advertisements, and online advertisements. For each consumer, the facility can use the collected information to determine when advertisements were, or may have been, presented to the consumer for each of the relevant advertising outlets or channels. The facility may process consumer data at the level of individual advertising units across the consumer's web-enabled or “connected” devices (e.g., computer, smart TV, personal digital assistant (pda), smart phone, cellular phone, tablet computer). An online advertising network may provide specific advertisement placement data for the consumer, such as the time the network presented an advertisement to a consumer and an indication of the website on which the advertisement was placed. As another example, an online video provider may provide an indication of advertisements presented to consumers visiting the provider's website. Similarly, the facility may collect data about the distribution of advertisements to consumers by email, such as when the emails were sent and to whom. Furthermore, the facility may infer consumer context and intent based on, for example whether the consumer is browsing from home, work, or from a mobile device at the time they received an advertisement or whether the consumer is browsing for general information, product or service comparison, price comparison, or to purchase a product or service. The facility may also determine the consumer's location based on, for example, a location-based service, GPS data, the consumer's IP address, and so on. In this manner, the facility gathers real-time information from various sources about the distribution of advertisements to consumers via different marketing channels and sub-channels. Additionally, information collected from an online retailer may provide data pertaining to a business outcome, such as an indication of how much revenue was generated as a result of the consumer, for example, purchasing an electronic version of the album, purchasing the album in CD format, purchasing a single song from the album, etc.

For each marketing channel associated with a marketing campaign, the facility analyzes the aggregated information to assess the performance of each marketing channel based on effect of resources allocated to the marketing channel on a business outcome, such as the generation of revenue. Furthermore, the facility may assess the performance of each marketing channel according to varying depths or levels of granularity. For example, for a marketing campaign that includes online marketing, the facility may analyze information related to how the advertisements in that campaign perform in the aggregate or may analyze information according to specific “sub-channels” associated with the online marketing channel, such as all advertisements placed by advertising networks (“advertising network marketing channel”) or all advertisements placed by a particular publisher website (“publisher website marketing channel”). In some examples, the facility analyzes the performance of a marketing campaign according to “deeper” or “higher” levels of granularity—“sub-channels” within “sub-channels”—such as the performance of advertisements placed by a specific advertising network, advertisements placed by a specific publisher website, advertisements placed during a certain time period, and so on.

As another example of varying levels of granularity, the facility may use information for an online marketing campaign to measure the performance or effectiveness of 1) a particular advertisement presented on a particular publisher's website at a specific time or during a specific time period, 2) a group of advertisements on a publisher's website, 3) a group of advertisements on a group of publishers' websites, 4) a single advertisement on a group of publishers' websites, and so on.

As another example, the facility may use collected information relating to various search marketing channels to measure the performance or effectiveness of resources allocated to 1) different search engines (each search engine corresponding to a different channel or sub-channel, 2) different products or tools provided by or associated with the search engines (each product or tool corresponding to a different channel or sub-channel), 3) different keywords purchased in conjunction different search engines (each keyword corresponding to a different channel or sub-channel, such as keywords purchased in conjunction with GOOGLE'S ADWORDS), and so on. Accordingly, the facility can utilize the collected information on varying levels of granularity for the purpose of measuring the performance or effectiveness of marketing campaigns according to any level of granularity provided by or discernable from the collected data.

As another example, the facility may analyze data collected for a television marketing channel based on associated sub-channels, such as the 11:45 am timeslot of the NBC affiliate in Madison, Wis. or the third commercial during the second commercial break of The Tonight Show in Denver, Colo. Alternatively, collected information may represent the performance or effectiveness of a group of advertisements, such as all advertisements displayed during American Idol in St. Louis, Mo. or all advertisements shown by the ABC affiliate in Raleigh, N.C. Accordingly, the facility is capable of analyzing the performance or effectiveness of a marketing campaign or campaigns at varying depths or levels of channel and sub-channel granularity.

In some examples, may the facility may track consumers across the various information sources with or without identifying each consumer. For example, the facility may use an email address associated with each consumer, cookie information passed from the consumer's browser, name and address information, credit card information, etc. to track the user as the user navigates from information source to information source. Thus, the facility can identify a consumer's interactions with a marketing campaign across several marketing channels or outlets and associate these interactions with results of the interactions based on data collected from other sources. In some examples, the collected information, or a portion thereof, may not include personally identifiable information (i.e., information that allows the facility to identify specific consumers). For example, an online publisher, to protect the privacy of its consumers, may provide information that does not identify consumers specifically. Rather, the online publisher may provide an indication of the behavior of groups of consumers based on, for example, age, income, profession, education level, geographic location, interests, and so on.

Using the aggregated data and information about how marketing resources are currently allocated, the facility can use regression techniques to generate models that represent the performance or effectiveness of the various marketing channels on a particular business outcome or outcomes. The models represent the true impact or effect of advertising resource allocation decisions on a particular business outcome or outcomes. For example, the facility may generate a model that relates advertising resource allocation decisions for different channels (e.g., the amount of money spent on advertising for each channel) to revenue for the advertiser. Thus, the models describe how business outcomes respond to, or are impacted by, changes to underlying driver variables, such as the amount of marketing resources allocated to different marketing channels. Often, these response effects are referred to as “lift factors.” The facility or other processes may use the lift factors to inform future marketing resource allocation decisions and dynamically improve the results of those decisions relative to a business outcome or outcomes.

In some embodiments, a response for a particular business outcome may be modeled using advertising variables and other external factors or causal variables. For example, sales revenue may depend on the allocation of marketing resources to television media and search engine media along with other related external factors, such as the economy, distribution, pricing, awareness (e.g., number of followers on Twitter or friends on Facebook), page views of Facebook or other websites, and so on. The facility can collect, analyze, and incorporate data for each of these external factors into a cross-media attribution model to provide additional information regarding the true impact of marketing resource allocations on business outcomes. In some cases, a causal variable may be an intermediate outcome and be similarly modeled using its own causal variables. For example, search engine media, which is a causal variable for sales revenue in the example above, may have a number of its own causal variables, such as television media, paid search clicks, and so on. Thus, the performance or true impact of marketing resources allocated to search engine media can be modeled using the causal variables related to search engine media and used to generate a model for sales revenue. One skilled in the art will understand that the causal variables for a particular outcome or intermediate outcome can be determined using any of a number of marketing science and consumer behavior paradigms. Additionally, other techniques, such as vector autoregressive methods, can be used to determine causal paths between user actions, intermediate outcomes, and final outcomes and any associated time lags (e.g., the time between a consumer seeing an advertisement on television and then performing an online search for that product or the time between a consumer performing an online search for a product and then purchasing that product online or in a store).

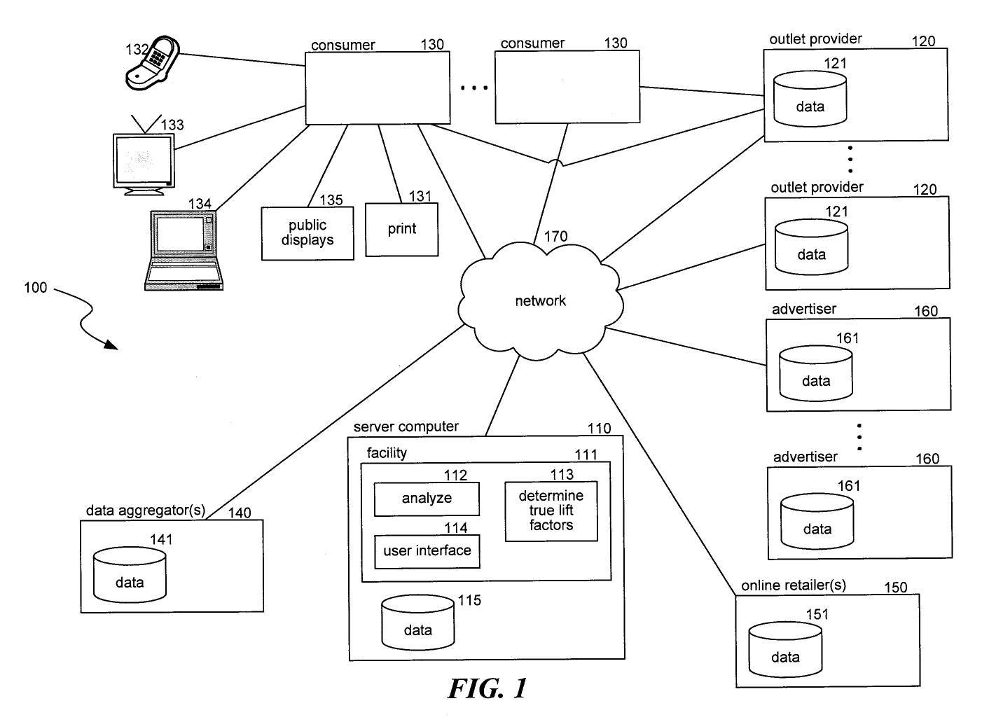

FIG. 1 is a block diagram of a representative environment 100 in which the facility may operate in some embodiments. In the depicted environment, a server computer 110 is coupled to various outlet providers 120, consumers 130, data aggregator 140, online retailer 150, and advertisers 160 via network 170. The server computer 110 includes software facility 111 and marketing data store 115, which stores information representing consumer interactions with marketing campaigns and results of those interactions collected from various sources, such as outlet providers 120, consumers 130, data aggregator(s) 140, online retailer 150, or advertisers 160. Software facility 111 includes analyze component 112, determine true lift factors component 113, and user interface 114. Analyze component 112 periodically collects and analyzes information representing consumer interactions and results of those interactions to dynamically provide true lift factors, each true lift factor corresponding to the impact of marketing resources allocated to a particular medium or channel on business outcomes. Determine true lift factors component 113 is invoked by analyze component 112 to generate a model from which lift factors, representing the relationship between the allocation of marketing resources and a business outcome, can be derived. User interface 140 provides an interface through which a user of the facility can interact with the facility. Outlet providers 120 represent providers of outlets or channels for the presentation of advertisements from advertisers 160 to consumers 130, such as publisher websites, television stations, cable television providers, radio stations, online advertising networks or exchanges, and so on. Each outlet provider 120 includes data store 121 which stores information related to the placement of advertisements, such as when the advertisements were presented, which advertisements were presented, whether the consumer interacted with the advertisement, the advertiser that provided the advertisement, etc. Data aggregator(s) 140, online retailer(s) 150, and advertisers 160 may store similar data in data stores 141, 151, and 161 respectively. Consumers 130 may interact with advertisements presented by outlet providers 120 or advertisers 160 through any medium or channel, such as print 131, cell phone or pda 132, television 133, computer 134, public displays 135, etc. In some cases, a consumer 130 may be coupled to an outlet provider 120 through a connection other than network 170, such as a connection between a consumer 130 and a cable television provider.

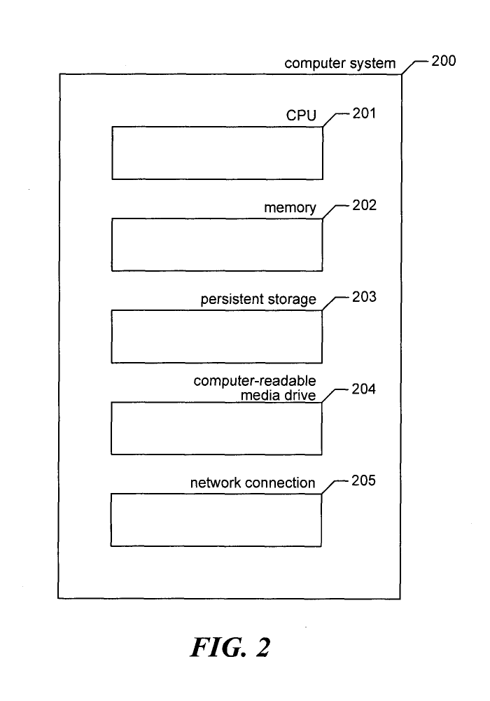

FIG. 2 is a block diagram showing some of the components typically incorporated in at least some of the computer systems and other devices on which the facility executes in some embodiments. The computing devices on which the facility is implemented may include one or more central processing units (“CPUs”) 201 for executing computer programs, a computer memory 202 for storing programs and data while they are being used, input devices (e.g., keyboard and pointing devices), output devices (e.g., display devices), and one or more persistent storage devices, such as a hard disk drive for persistently storing programs and data, a computer-readable media drive 204, such as a CD-ROM drive, for reading programs and data stored on a computer-readable medium. The memory and storage devices are computer-readable media that may be encoded with computer-executable instructions that implement the facility, which means a computer-readable medium that contains the instructions. In addition, the instructions, data structures, and message structures may be stored or transmitted via network connection 205 using a data transmission medium, such as a signal on a communications link, and may be encrypted. Various communications links may be used, such as the Internet, a local area network, a wide area network, a point-to-point dial-up connection, a cell phone network, and so on.

Embodiments of the facility may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on.

The facility may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. While computer systems configured as described above are typically used to support the operation of the facility, those skilled in the art will appreciate that the facility may be implemented using devices of various types and configurations, and having various components.

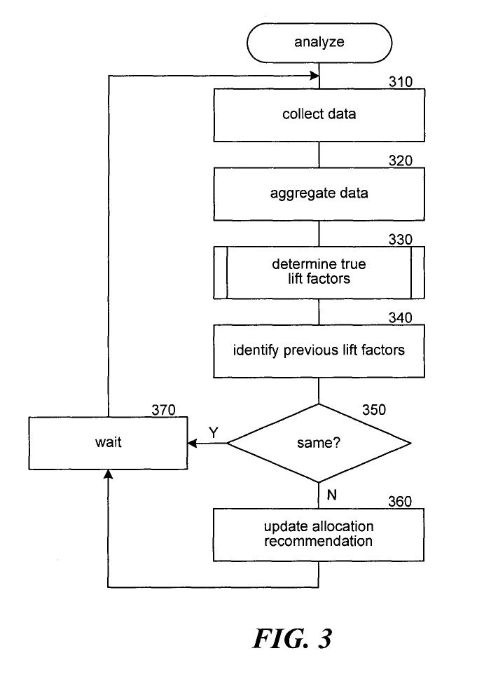

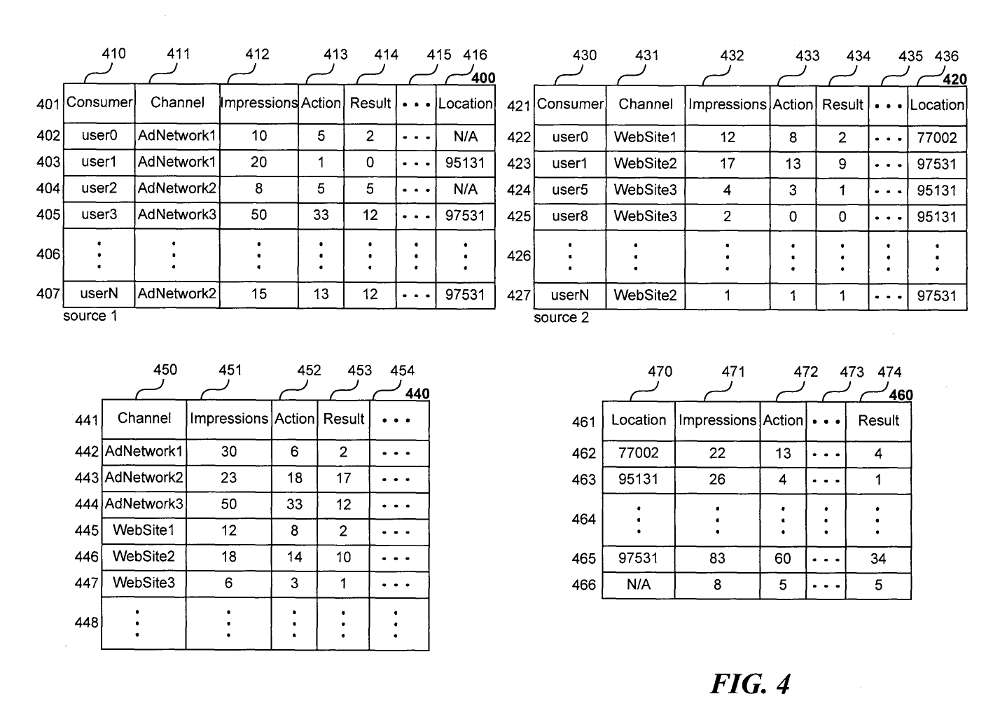

FIG. 3 is a flow diagram illustrating the processing of the analyze component 112 in some embodiments. The component periodically collects and analyzes information characterizing consumer interactions and results of those interactions to provide true lift factors representing the true impact or effect of marketing resource allocation decisions on a business outcome or outcomes. The component optimizes a marketing resource allocation recommendation based on the analysis of actual marketing resource allocation decisions and actual user interactions with marketing campaigns thereby allowing for the dynamic adjustment of allocation decisions. The outputs of the optimization provide a marketing resource allocation recommendation for a variety of media or channels related to a particular marketing campaign. The optimized recommendation may include an improved mix of marketing elements, improved timing of marketing activities, and an improved balance across customer segments, brands, and markets. In block 310, the component collects data from a plurality of sources, such as advertisers, outlet providers, consumers, data aggregators, online retailers, etc. The facility may collect information in real-time in order to provide real-time feedback or may collect the information periodically, such as once per hour, once per day, once per week, and so on. In block 320, the component aggregates the collected data according to any of a number of attributes, such as aggregating the data by marketing channel, an identifier associated with each consumer, consumer location, consumer age, consumer profession, consume income, etc. FIG. 4, discussed in further detail below, is a data structure diagram illustrating data collected from different sources and how that information may be aggregated in some embodiments.

In block 330, the component invokes a determine true lift factors component to determine the true impact of marketing channels on a business outcome or outcomes, such as revenue. The true impact of a marketing channel on a business outcome represents the effect that resources allocated to that marketing channel have on the business outcome; the greater the effect, the greater the impact. In block 340 the component identifies lift factors previously used as a basis for allocating marketing resources. These lift factors may have been based on previously estimated or predicted data points, a previous iteration of the analyze component itself, etc. In decision block 350, if the determined true lift factors are equal to the identified previous lift factors, then the component continues at block 370, or else the component continues at block 360. In block 360, the component dynamically updates or adjusts a previously generated marketing resource allocation recommendation using the based on the determined true lift factors and then proceeds to block 370. In block 370, the components waits for an event to trigger the process to restart (e.g., a request from a user, a predetermined time, completion of a countdown timer) and then loops back to block 310 to collect additional data. In some embodiments, the component may continuously collect data from various sources rather than performing this step during processing of the analyze component.

FIG. 4 is a data structure diagram illustrating data collected from different sources for a single marketing campaign and how that data may be aggregated in some embodiments. Table 400 represents data collected from one source, “source 1,” while table 420 represents data collected from another source, “source 2.” In this example, the data represents user interactions with an online marketing campaign that includes advertisements presented by advertising networks and by websites directly.

In this example, rows 401 and 421 include labels for each of columns 410-416 and 430-436 respectively while rows 402-407 and 422-427 include information for different consumers (e.g. “user0” and “user1”). Rows 406 and 426 indicate that tables 400 and 420 may include information for consumers not represented. Columns 410-416 and 430-436 represent different fields of data collected for the different consumers, including “Consumer” columns 410 and 430, “Channel” columns 411 and 431, “Impressions” columns 412 and 432, “Action” columns 413 and 433, “Result” columns 414 and 434, and “Location” columns 416 and 436. Columns 415 and 435 indicate that the tables may include additional fields not represented, such as time, advertisement, marketing campaign, etc.

Row 402 comprises information collected for a consumer identified by the identifier “user0.” The information includes the number of times an advertisement for a particular campaign was presented to user0 (“Impressions”), 10, the number of times that consumer took an action (e.g., clicked on an advertisement or watched an entire video advertisement) with respect to those impressions (“Action”), 5, and a quantified result (e.g., the number of times the consumer made a purchase or other transaction or the revenue generated by the associated actions) of those actions (“Results”), 2, and an indication of user0's location (“Location”), such as the ZIP code in which the user resides. Rows 403-407 include information collected about different users from the same source (“source 1”) while rows 422-427 represent information about users collected from a different source (“source 2”). In some examples, the tables may include separate rows for each impression and include additional information about any action or activity associated with the impression, such as a price the consumer paid for an offering or service. In some examples, such information may be stored in separate tables.

In this example, table 440 represents the aggregation of data in tables 400 and 420 based on marketing channels. Accordingly, table 440 provides an indication of the total interactions with a marketing campaign across different channels collected from different sources. In this example, row 441 includes labels for each of columns 450-454 while rows 442-447 store information representing the performance or effectiveness of a marketing campaign in different marketing channels (e.g. “AdNetwork1” and “ABC”). Row 448 indicates that table 440 may include additional channels not represented. Columns 450-454 represent different fields of data collected for the different marketing channels represented in table 440.

In this example, table 460 represents the aggregation of tables 400 and 420 based on the locations of the consumers. Accordingly, table 460 provides an indication of the performance or effectiveness of a marketing campaign in different geographic areas across different marketing channels. In this example, row 461 includes labels for each of columns 470-474 while rows 462-466 include marketing information for different locations represented in the collected data (e.g., “77002” and “95131”). Row 464 indicates that table 460 may include consumers not represented. Columns 470-474 represent different fields of data collected for different consumers represented in table 460.

Although two sources are shown in this example, one skilled in the art will understand that data may be collected from any number of unique and independent data sources. Accordingly, the facility may process the data collected from different sources to track the “path” of the user across different locations where the user can interact with a marketing campaign or offering, such as different marketing channels/sub-channels, online commerce sites, etc. For example, an online retailer may only provide information about when consumers purchased a particular product without information about when advertisements were presented to the consumers. On the other hand, an online advertising network or networks may provide advertisement impression information (e.g., when and how advertisements were presented to the consumers). The facility can combine the information collected from the online retailer and the advertising network(s) to assess the performance or effectiveness of a marketing campaign. Furthermore, the facility can generate a complete picture of the performance or effectiveness of various marketing campaigns by completing information missing from one source with information provided by another source. For example, the information collected from “source 1” does not include location information for consumer user0. The information collected form “source 2,” however, does provide this information, which is present in the aggregated information represented in table 440. By combining data collected from different sources, the facility can assess how users or groups of users interact with different marketing campaigns and how different marketing channels impact particular business outcomes. Furthermore, although two aggregation samples are shown, one skilled in the art will understand that the data may be aggregated according to any field or “dimension” and that the aggregation may be further refined using additional fields. Additionally, one skilled in the art will recognize that while FIG. 4 provides an illustration that is easily comprehensible by a human reader, the actual information may be stored using different data structures and data organizations.

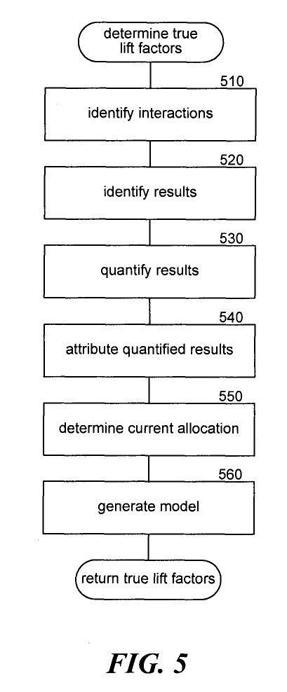

FIG. 5 is a block diagram illustrating the processing of a determine true lift factors component in some embodiments. In block 510, the component identifies consumer interactions among the collected data, such as whether a consumer clicked on an advertisement, opened an e-mail containing an advertisement, etc. In block 520, the component identifies results of those interactions, such as whether a consumer purchased an offering associated with advertisement or marketing campaign. In block 530, the component quantifies the results based on a desired business outcome or business outcomes. For example, if the desired outcome of the marketing campaign is to generate traffic to a website, an interaction with an advertisement that results in a consumer visiting the website may be assigned a value of “1” while other interactions are assigned a value of “0.” As another example, if the desired outcome is to sell a product or generate revenue, the result of an interaction may be assigned a value based on how many products were sold or how much revenue the interaction generated.

In block 540, the component attributes portions of the quantified results to marketing channels associated with the related interactions. For example, a consumer may have purchased a particular product after viewing advertising materials for the product through different marketing channels, such as online advertisements, email advertisements, television commercials, and print. Although the consumer may have purchased the product soon after clicking on an online advertisement, the facility may attribute some of the revenue generated by the purchase to other channels of the marketing campaign for the product.

In some examples, the component may attribute the quantified results based on time (e.g., how long ago the advertisements were presented to the user or how much time passed between the presentation of an advertisement and the consumer's purchase), the number of advertisements presented to the consumer via each channel, the number of advertisements presented to a user before the user purchased an offering, and so on. For example, the component may attribute a greater portion of the quantified result to more recent impressions and a smaller portion to earlier impressions. In this manner, the component can eliminate or reduce biases that may appear when measuring the performance or effectiveness of a marketing campaign across different marketing channels, such as a “last click bias,” a “first click bias,” etc., when desired. Alternatively, the component may attribute the quantified results to marketing channels or sub-channels based on the total number of advertisements presented by each channel or sub-channel compared to the total number of advertisements presented for the marketing campaign in its entirety or by a specific channel/sub-channel. By way of example, if a consumer purchased a product for $100 after receiving forty advertisements presented by advertising networks and ten advertisements distributed to the consumer by email, the component may attribute $80 to an adverting networks marketing channel and $20 to an email marketing channel or vice versa, and so on. Furthermore, the facility may attribute the quantified results to sub-channels, such as a marketing channel for a specific advertising network or email marketing company.

In block 550, the component determines the current allocation of marketing resources to the marketing channels. In block 560, the component uses a statistical regression analysis technique, such as a linear or non-linear regression method, to dynamically generate a model correlating a current marketing resource allocation to a business outcome or business outcomes based on the attribution of results to the various marketing channels. For example, the component may use a multivariate linear regression technique to generate coefficients for each marketing channel. The generated coefficients represent the impact of each marketing channel on a business outcome or business outcomes. As an example, the model may be represented by the form:

$$y = {\sum }_{i = 0}^{n - 1} {β}_{i} {x}_{i} + C ,$$

where y corresponds to a business outcome, n represents the number of marketing channels considered, βᵢ represents a lift factor for the i^{th} marketing channel considered, and xᵢ represents the amount of marketing resources allocated to the i^{th} marketing channel, and C represents an intercept and/or error value. The generated model represents the true impact of the marketing resources allocated to different marketing channels on a business outcome or business outcomes. Although a linear regression model is described, one skilled in the art will recognize that the facility may be use any type of regression model. The component then returns the determined lift factors, such as the generated coefficients, for each of the marketing channels, which may include channels associated with different market media.

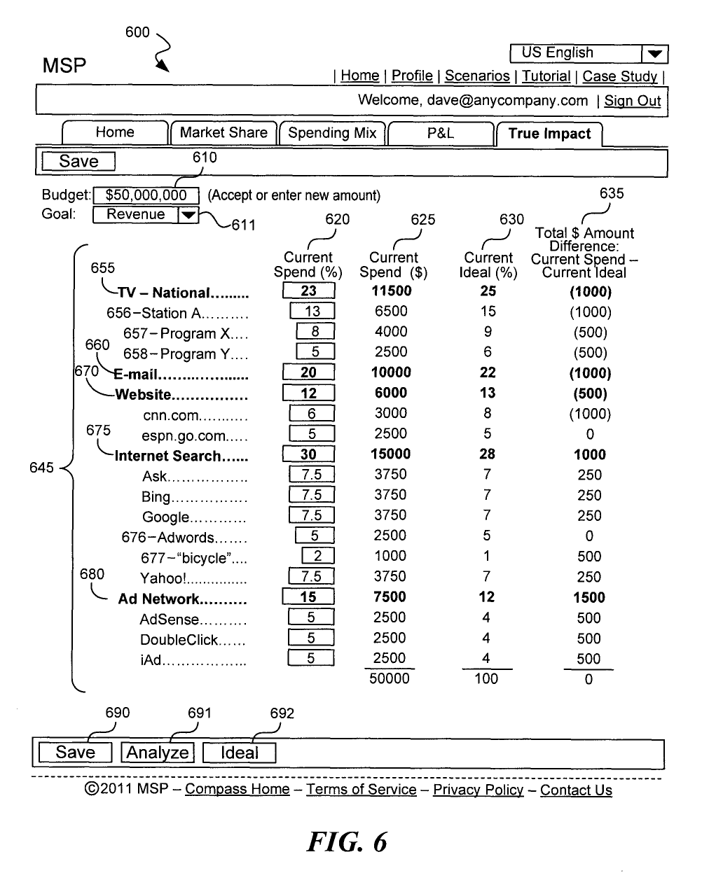

FIG. 6 is a display page 600 illustrating a marketing resource allocation recommendation and configuration page in some embodiments. Display page 600 includes an overall budget 610 available for allocation to various marketing channels for a particular period (e.g., week, month, and year). A user may edit the budget if desired to see the effect on allocation information shown below. Drop-down list 611 allows a user to select from among different business outcome goals for analysis and recommendation. In this example, “Revenue” is selected. Accordingly, the recommendation in this example represents the market resource allocation that optimizes overall revenue in this scenario. When a user selects a different goal, the facility automatically updates the recommendation to optimize the selected goal. The display page 600 also includes a table 645 showing various information for each of a number of marketing channels. Each row 655, 656, 657, 658, 660, 670, 675, and 680 identifies a different marketing channel where an advertiser can allocate marketing resources. In this example, marketing channel “TV—National” row 655, which corresponds to a national television broadcasting marketing channel, includes sub-channel “Station A” row 656 corresponding to a national television station where an advertiser may allocate marketing resources (e.g., ABC or NBC), which itself includes marketing sub-channels “Program X” row 657 and “Program Y,” row 658 each corresponding to a different television program broadcast by Station A where an advertiser may allocate marketing resources.

As another example, marketing channel “Internet Search” row 675, which corresponds to online search engines, includes marketing sub-channels “Ask,” “Bing,” “Google,” and “Yahoo!,” each representing a different search engine marketing channel where an advertiser can allocate marketing resources. Each of these search engine marketing channels or sub-channels may include their own sub-channels representing services or features associated with the search engine, such as “AdWords” row 676 representing an advertising service provided by Google that allows advertisers to select or bid on words that cause their advertisements to be displayed to users of the search engine. Additional rows may be included for each of the words that the advertiser has selected or bid on with respect to Google's Adwords, such as “bicycle” row 677 corresponding to a sub-channel where an advertiser may allocate marketing resources.

Each row is further divided into the following columns: “Current Spend (%)” column 620, “Current Spend ($)” column 625, “Current Ideal (%)” column 630, and “Total $ Amount Difference: Current Spend—Current Ideal” column 635. “Current Spend (%)” column 620 represents the amount of the marketing budget 610 that the advertiser is currently allocating to each marketing channel as a percentage of the overall budget. Furthermore, a user may edit the entries in each of the fields represented in “Current Spend (%)” column 620 to modify the current allocation of the marketing budget. “Current Spend ($)” column 625 represents the amount of the marketing budget 610 allocated to each marketing channel in thousands (1000s) of dollars. The amounts represented in each row include the amount allocated to the marketing channel in its entirety (i.e., including its sub-channels). For example, a total of 12%, or $6,000,000 of the marketing budget, is currently allocated to the website marketing channel (e.g., advertisements placed with specific websites) with 6%, or $3,000,000, being allocated to the CNN.COM channel (e.g., advertisements placed with CNN.COM) and 5%, or $2,500,000, being allocated to ESPN.GO.COM (e.g., advertisements placed with ESPN.GO.COM). Accordingly, 1%, or $500,000, of the marketing budget is allocated to the website marketing channel generally as opposed to being allocated to a specific sub-channel or sub-channels, such as a particular website, time period, etc.

“Current Ideal (%)” column 630 represents the current ideal marketing resource allocation based on the lift factors determined by the facility as discussed above with respect to FIG. 5. “Total $ Amount Difference: Current Spend—Current Ideal” column 635 represents the difference in terms of dollars between a current allocation and the current ideal allocation of marketing resources for each marketing channel. For example, row 680 indicates that 15% of the marketing budget, or $7,500,000, is currently allocated to an advertising network marketing channel and that the facility is recommending a 3%, or $1,500,000, reduction in the allocation of resources to the advertising marketing channel based on the true impact of marketing resource allocation. In other words, the advertiser is allocating $1,500,000 too much to the advertising network marketing channel. Display page 600 further includes “Save” button 690, which allows a user to save any changes to the “Current Spend (%)” values or budget 610, “Analyze” button 691, which invokes the analyze component, and “Ideal” button 692 which automatically populates the “Current Spend (%)” fields of column 620 with values from “Current Ideal (%)” column 635.

Advertisers may divide or categorize channels differently. For example, one advertiser may associate “Ad Network,” “Internet Search,” and “Website” marketing channels with a higher level marketing channel, such as an “Online” marketing channel such that the “Ad Network,” “Internet Search,” and “Website” marketing channels are sub-channels of the “Online” marketing channel.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. Those skilled in the art will further appreciate that the depicted flow charts may be altered in a variety of ways. For example, the order of the steps may be rearranged, steps may be performed in parallel, steps may be omitted, or other steps may be included.

Although the subject matter has been described in language specific to structural features and/or methodological acts, it is to be understood that the subject matter defined in the appended claims is not necessarily limited to the specific features or acts described above. For example, the facility may be used to generate true lift factors for an advertiser across multiple marketing campaigns, for an entire industry, or for a specific marketing channel or channels across all advertisers or a group of advertisers. The specific features and acts described above are disclosed as example forms of implementing the claims. Accordingly, the technology is not limited except as by the appended claims.

1. A method, performed by a computer system having a memory and a processor, the method comprising:
collecting user interaction data characterizing interactions of a plurality of users with a marketing campaign that comprises presenting marketing messages via a plurality of marketing channels associated with the marketing campaign, the marketing campaign having an associated business outcome;
collecting user result data representing results of the interactions of the plurality of users with the marketing campaign;
aggregating the collected user interaction data and user result data;
quantifying, with the processor, the results of the interactions of the plurality of users with the marketing campaign;
attributing the quantified results to the plurality of marketing channels associated with the marketing campaign;
assessing performance of the marketing campaign with respect to each of the plurality of marketing channels based at least in part on the aggregated data and the attribution of the quantified results to the plurality of marketing channels;
determining, for each marketing channel associated with the marketing campaign, an amount of marketing resources currently allocated to the marketing channel;
based on the determined amounts of marketing resources allocated to each marketing channel and the attribution of the quantified results, generating a model comprising lift factors for each marketing channel associated with the marketing campaign on the business outcome, wherein the lift factors are generated based at least in part on the assessed performance of the marketing campaign;
identifying previously estimated lift factors for each marketing channel associated with the marketing campaign; and
in response to determining that the identified previously estimated lift factors are not the same as the lift factors of the generated model, updating a marketing allocation recommendation for each of a plurality of marketing channels associated with the marketing campaign based on the lift factors of the generated model.

2. The method of claim 1 wherein the user interaction data is collected from a first plurality of unique data sources.

3. The method of claim 2 wherein the first plurality of unique data sources comprises at least one advertising network and at least one publisher website.

4. The method of claim 1 wherein the user result data is collected from a second plurality of unique data sources.

5. The method of claim 4 wherein the second plurality of unique data sources comprises at least one data aggregator and at least one online retailer.

6. The method of claim 1, further comprising:
adjusting a current allocation of marketing resources based on the generated model.

7. The method of claim 1 wherein the plurality of marketing channels associated with the marketing campaign comprises an e-mail channel, a search channel, a video channel, and a website channel.

8. The method of claim 1 wherein the marketing campaign is a cross-media marketing campaign.

9. A computer system having a memory and a processor, the computer system comprising:
a component configured to collect interaction data characterizing interactions with a cross-channel marketing campaign from a plurality of sources;
a component configured to collect result data representing results of the interactions with the cross-channel marketing campaign from a plurality of sources;
a component configured to aggregate the collected interaction data and the collected result data;
a component configured to attribute the represented results to a plurality of marketing channels associated with the cross-channel marketing campaign;
assessing performance of the cross-channel marketing campaign with respect to each of the plurality of marketing channels associated with the cross-channel marketing campaign based at least in part on the aggregated data and the attribution of the represented results to the plurality of marketing channels; and
a component configured to generate lift factors for each channel associated with the cross-channel marketing campaign based on the assessed performance of the cross-channel marketing campaign,
wherein at least one of the components comprises computer-executable instructions stored in memory for execution by the computer system.

10. The computer system of claim 9, further comprising:
a component configured to identify previously estimated lift factors for each channel associated with the cross-channel marketing campaign; and
a component configured, in response to determining that the identified previously estimated lift factors are not the same as the generated lift factors, to update a marketing allocation recommendation for each of a plurality of channels associated with the cross-channel marketing campaign.

11. The computer system of claim 9 wherein the plurality of channels associated with the cross-channel marketing campaign comprises an e-mail channel, a search channel, a video channel, and a website channel.

12. The computer system of claim 9 wherein interaction data and result data are collected from different sources.

13. The computer system of claim 9, further comprising:
a component configured to adjust a current allocation of marketing resources based on the generated lift factors.

14. The computer system of claim 9 wherein interaction data is collected from a cable television provider and wherein result data is collected from an online retailer.

15. A computer-readable storage medium containing instructions that, when executed by a computer, cause the computer to perform operations comprising:
collecting, from a first source, data representing user interactions with an advertising campaign associated with an offering;
collecting, from a second source, data representing user actions associated with the offering;
aggregating the collected data;
attributing at least a portion of each of the user actions associated with the offering to at least one of a plurality of channels associated with the advertising campaign;
assessing performance of the advertising campaign with respect to each of the plurality of channels based at least in part on the aggregated data and the attribution of the user actions to the plurality of channels; and
determining lift factors for each of the plurality of channels based on the assessed performance of the advertising campaign.

16. The computer-readable storage medium of claim 15 wherein assessing performance of the advertising campaign comprises generating a model using a regression technique.

17. The computer-readable storage medium of claim 15, the operations further comprising:
updating the determined lift factors based at least in part on determined lift factors.

18. The computer-readable storage medium of claim 15 wherein the first source comprises an advertising network.

19. The computer-readable storage medium of claim 15 wherein the plurality of marketing channels comprises a search channel, an advertising networks channel, and an e-mail channel.

20. The computer-readable storage medium of claim 15, the operations further comprising:
adjusting a current allocation of marketing resources based on the determined lift factors for each of the plurality of marketing channels.

21. The computer-readable storage medium of claim 15 wherein the plurality of marketing channels comprises a television marketing channel and at least one sub-channel associated with the television marketing channel.

22. The computer-readable storage medium of claim 15 wherein at least one of the user interactions with the advertising campaign associated with the offering is a first user viewing an online advertisement for the offering, wherein at least one of the user interactions with the advertising campaign associated with the offering is the first user viewing a television commercial for the offering, wherein at least one of the user actions with the offering is a purchase, and wherein attributing at least a portion of each of the user actions comprises attributing a first portion of the revenue generated by the purchase to an online advertisement marketing channel and attributing a second portion of the revenue generated by the purchase to a television marketing channel.

23. The computer-readable storage medium of claim 22 wherein the first portion of revenue attributed to the online advertisement marketing channel is based on the amount of time between the first user viewing the online advertisement for the offering and the purchase, wherein the second portion of the revenue attributed to the television marketing channel is based on the amount of time between the first user viewing the television commercial for the offering and the purchase, and wherein the amount of the first portion of revenue attributed to the online advertisement marketing channel is different from the second portion of revenue attributed to the television marketing channel.
